(19) United States
(12) Patent Application Publication
(10) Pub. No.: US 2007/0012537 A1
(43) Pub. Date: Jan. 18, 2007

(54) Hydrodynamic torque converter

(75) Inventors: Thorsten Krause, Buehl (DE); Bruno Mueller, Sasbach (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/485,000

(22) Filed: Jul. 12, 2006

(30) Foreign Application Priority Data
Jul. 14, 2005 (DE) 10 2005 032 766.4

(51) Int. Cl. F16H 45/02

(52) U.S. Cl. 192/3.29

(57) ABSTRACT

The present invention relates to a hydrodynamic torque converter having a driving pump wheel and a driven turbine wheel, which is situated in the housing so it is rotatable, which is attachable to the output shaft of an internal combustion engine, and having a converter bypass clutch which has a piston, which is connected to the housing with the aid of a coupling spring unit so it is rotationally fixed but movable in the axial direction. In order to provide a hydrodynamic torque converter through which the engagement of the converter bypass clutch is improved, the coupling spring unit has flow conduction means, which influence the speed of a flow medium between the piston and the turbine wheel.

### CROSS REFERENCE TO RELATED APPLICATIONS

This patent application claims priority of German Patent Application No. 10 2005 032 766.4 filed Jul. 14, 2005, which application is incorporated herein by reference.

### FIELD OF THE INVENTION

The present invention relates to a hydrodynamic torque converter having a driving pump wheel and a driven turbine wheel, which is situated in a housing so it is rotatable, which is attachable to the output shaft of an internal combustion engine, and having a converter bypass clutch, which has a piston, which is connected to the housing so it is rotationally fixed but movable in the axial direction with the aid of a coupling spring unit.

### BACKGROUND OF THE INVENTION

German Published Application DE 44 33 256 A1 discloses a hydrodynamic torque converter having a bypass clutch, which comprises a housing attachable to the driveshaft of the internal combustion engine having an at least approximately radially running wall and a bypass clutch situated between this wall and the turbine wheel having a lamella rotationally connected to the turbine wheel. The turbine wheel may be operationally linked to the housing on one side and to an axially displaceable piston of the bypass clutch under the effect of hydraulic pressure on at least the piston on the other side and the piston being provided axially between turbine wheel and housing wall, a first space which may have flow agent pressure applied to it to close the clutch being provided between turbine wheel and piston and a second space which may have flow agent pressure applied to it to open the clutch being provided between piston and housing wall. Means are provided in the first and/or in the second space to reduce the rotational velocity difference between the lower rotational velocity of the flow agent existing in the event of open or slipping bypass clutch in traction operation in the pressure chamber between turbine and piston and the higher rotational velocity of the flow agent existing in the pressure chamber between piston and housing wall.

### BRIEF SUMMARY OF THE INVENTION

In a preferred embodiment, the torque converter includes the coupling spring unit which has multiple leaf spring units, which extend between the housing and the piston and on which the flow conduction means are provided. Production of the flow conduction means, which is simple and cost-effective to implement in manufacturing, is thus made possible.

In a further preferred embodiment, the torque converter includes the leaf spring units which comprise at least one leaf spring, which is attached to both the housing and the piston, which is extended beyond the attachment point at which the leaf spring is attached to the piston in order to form a flow conduction scoop. Through the one-piece connection between the flow conduction scoop and the leaf spring, the production of the flow conduction means is significantly simplified.

In a further preferred embodiment, the torque converter includes the leaf spring which is attached radially to the exterior of the piston. The peripheral velocity of the flow conduction means may thus be increased.

In a further preferred embodiment, the torque converter includes flow conduction means which are provided between the turbine wheel and the piston in a space, which may have pressure applied to it by the flow medium to close the converter bypass clutch. Alternatively or additionally, flow conduction means may also be provided in a further space, which may have pressure applied to it by the flow medium, provided between the piston and the housing for opening the converter bypass clutch.

In a further preferred embodiment, the torque converter comprises the design of the flow conduction scoop which is tailored to the external contour of the turbine wheel. The flow conduction scoop is preferably implemented as curved per se.

In a further preferred embodiment, the torque converter includes the flow conduction scoop which has an edge area facing toward the turbine wheel, which, viewed in longitudinal section through the torque converter, is implemented in the shape of a circular arc. The overall space delimited by the turbine wheel may thus be exploited optimally.

In a further preferred embodiment, the torque converter includes the flow conduction scoop which is angled away from the area at which the leaf spring is attached to the piston. The angle between this area and the flow conduction scoop is preferably approximately 90°.

The object of the present invention is to provide a hydrodynamic torque converter according to the preamble of claim 1, by which the engagement of the converter bypass clutch is improved.

The object is achieved in a hydrodynamic torque converter having a driving pump wheel and a driven turbine wheel, which is situated in a housing so that it is rotatable, which is attachable to the output shaft of an internal combustion engine, and having a converter bypass clutch. The converter bypass clutch has a piston, which is connected to the housing s6 it is rotationally fixed but movable in the axial direction with the aid of a coupling spring unit, in that the coupling spring unit has flow conduction means which influence the speed of a flow medium between the piston and the turbine wheel. Through the attachment of flow conduction means to the coupling spring unit, the speed of the flow medium between the piston and the turbine and therefore also the dynamic pressure at the beginning of the engagement of the converter bypass clutch may be easily used to raise converter bypass clutch faster.

Further advantages, features, and details of the present invention result from the following description, in which an exemplary embodiment is described in detail with reference to the drawing. The features cited in the claims and in the description may each be significant to the present invention individually or in any arbitrary combination.

### BRIEF DESCRIPTION OF THE DRAWINGS

The nature and mode of operation of the present invention will now be more fully described in the following detailed description of the invention taken with the accompanying drawing figures, in which:

FIG. 1 is a hydrodynamic torque converter in longitudinal section; and,

FIG. 2 is a view of a hydrodynamic torque converter section taken generally along line II-II in FIG. 1.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred embodiment, it is to be understood that the invention as claimed is not limited to the preferred embodiment.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

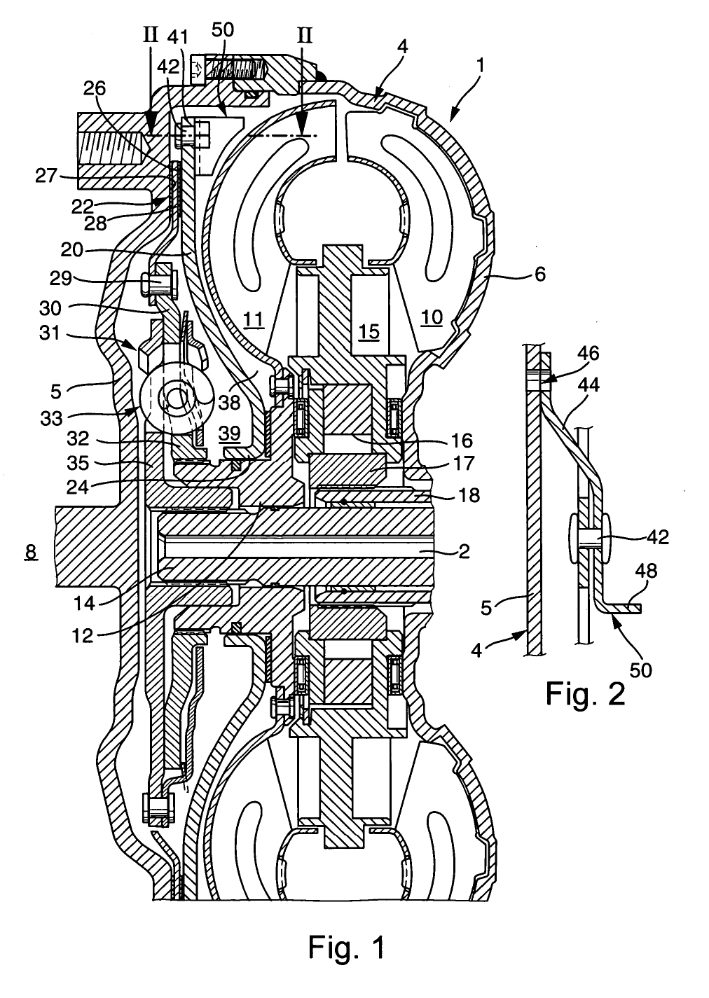

FIG. 1 shows hydrodynamic torque converter 1 in longitudinal section. Torque converter 1 is situated concentrically to rotational axis 2 and has housing 4 having drive-proximal housing wall 5 and drive-distal housing wall 6. The terms drive-proximal and drive-distal relate to internal combustion engine 8, which forms the drive in the drive train of a motor vehicle and is indicated only by reference number 8 in FIG. 1. Drive-proximal housing wall 5 is connected rotationally and fixed to the output shaft, in particular the crankshaft, of internal combustion engine 8. Drive-distal housing wall 6 is assembled in a unit with pump wheel 10 of hydrodynamic torque converter 1.

Turbine wheel 11, which is attached radially on the interior to turbine wheel hub 12, is situated between pump wheel 10 and drive-proximal housing wall 5. Turbine wheel hub 12 is preferably connected rotationally fixed to input shaft 14 of a transmission (not shown). Stator 15 is situated between turbine wheel 11 and pump wheel 10, which is guided via freewheel 16 on rotor hub 17, which is situated via teeth on housing-fixed tubular part 18. Piston 20 of converter bypass clutch 22 is situated between turbine wheel 11 and drive-proximal housing wall 5. Piston 20 has shoulder 24 radially on the interior, which is mounted radially on the exterior of turbine wheel hub 12 so it is rotatable and axially displaceable. Piston 20 has friction surface 26 radially on the exterior, which is situated facing toward internal combustion engine 8 and opposite friction surface 27, which is provided on the side of drive-proximal housing wall 5 facing away from internal combustion engine 8.

Intermediate lamella 28 is situated between two friction surfaces 26 and 27, which is attached radially on the interior with the aid of rivet connections 29 to input part 30 of torsional vibration damper 31. Input part 30 has hub part 32 radially on the interior, which is situated on turbine wheel hub 12 so it is rotationally fixed but axially displaceable. Input part 30 of torsional vibration damper 31 is coupled in a known way, with energy storage elements 33 interposed, in particular bow springs, to output part 35 of torsional vibration damper 31. Output part 35 of torsional vibration damper 31 is mounted radially on the interior on one end of input shaft 14 of the transmission so it is rotationally fixed but axially displaceable.

Intermediate lamella 28, which carries a friction coating, may be pressed using piston 20 movable in the axial direction against drive-proximal housing wall 5. Piston 20 connected rotationally fixed to housing 4 divides the space between drive-proximal housing wall 5 and turbine wheel 11 into two spatial areas 38 and 39. Spatial area 38 is also referred to as drive-distal spatial area. Spatial area 39 is also referred to as drive-proximal spatial area. Two spatial areas 38 and 39 are fillable via supply channels (not shown) with a hydraulic medium, which is also referred to as a flow medium, with the aid of a pump. Via a suitable control unit, spatial areas 38 and 39 may have pressure applied to them in a targeted way, through which an axial movement of piston 20 is caused. By applying pressure to drive-distal spatial area 38, converter bypass clutch 22 may be at least partially closed. If the pressure in drive-proximal spatial area 39 is controlled in relation to the pressure in drive-distal spatial area 38 in such way that piston 20 is displaced axially in the direction of turbine wheel 11, converter bypass clutch 22 is at least partially opened.

Multiple leaf spring elements 44 are attached to outer circumference 41 of piston 20 with the aid of rivet connections 42. It may be seen in FIG. 2 that leaf spring element 44 is attached at one of its ends with the aid of fasteners 46 to housing wall 5 of housing 4. Leaf spring element 44 provides a rotationally fixed connection between piston 20 and housing 4, which nonetheless allows an axial movement of piston 20 in relation to housing 4. End 48 angled away from leaf spring element 44 forms flow conduction scoop 50 in drive-distal spatial area 38 between piston 20 and turbine wheel 11.

The design of flow conduction scoop 50 is tailored to the design of turbine wheel 11 on its edge facing toward turbine wheel 11. The end of leaf spring element 44 which projects beyond the connection point to piston 20 is designed according to the present invention in such way that it forms a pump impeller. In this way, the speed of the hydraulic medium, preferably oil, between piston 20 and turbine wheel 11 may be increased. This has the result that the dynamic pressure also increases in this area.

### REFERENCE NUMBERS

1 torque converter
2 rotational axis
4 housing
5 drive-proximal housing wall
6 drive-distal housing wall
8 internal combustion engine
10 pump wheel
11 turbine wheel
12 turbine wheel hub
14 inputshaft
15 stator
16 freewheel
17 rotor hub
18 tube
20 piston
22 converter bypass clutch
24 shoulder
26 friction surface
27 friction surface
28 intermediate lamellae
29 rivet connection
30 input part
31 torsional vibration damper
32 hub part
33 energy storage element
35 output part
38 drive-proximal spatial area
39 drive-distal spatial area
41 circumference
42 rivet connection
44 leaf spring element
46 attachment point
48 angled end
50 flow conduction element

What is claimed is:

1. A hydrodynamic torque converter having a driving pump wheel (10) and a driven turbine wheel (11), which is situated in a housing (4) so it is rotatable, which is attachable to an output shaft of an internal combustion engine (8), and having a converter bypass clutch (22), which has a piston (20), which is connected with the aid of a coupling spring unit (44) to the housing (4) so it is rotationally fixed but movable in the axial direction, wherein the coupling spring unit (44) which has flow conduction means (50) which influences the speed of a flow medium between the piston (20) and the turbine wheel (11).

2. The hydrodynamic torque converter according to claim 1, wherein the coupling spring unit comprises multiple leaf spring units (44), which extend between the housing (4) and the piston (20) and on which the flow conduction means (50) are provided.

3. The hydrodynamic torque converter according to claim 2, wherein the leaf spring units each comprise at least one leaf spring (44), which is attached to both the housing (4) and also the piston (20), and is extended beyond the attachment point at which the leaf spring (44) is attached to the piston (20) in order to form a flow conduction scoop (50).

4. The hydrodynamic torque converter according to claim 3, wherein the leaf spring (44) is attached radially on the exterior to the piston (20).

5. The hydrodynamic torque converter according to claim 4, wherein the flow conduction means (50) are provided between the turbine wheel (11) and the piston (20) in a space (38) which may have pressure applied to it by a flow medium to close the converter bypass clutch (22).

6. The hydrodynamic torque converter according to claim 3, wherein the design of the flow conduction scoop (50) is tailored to the external contour of the turbine wheel (11).

7. The hydrodynamic torque converter according to claim 3, wherein the flow conduction scoop (50) has an edge area facing toward the turbine wheel (11), which is implemented in the shape of a circular arc viewed in longitudinal section through the torque converter (1).

8. The hydrodynamic torque converter according to claim 3, wherein the flow conduction scoop (50) is angled away from the area at which the leaf spring (44) is attached to the piston.
